(19) United States
(12) Patent Application Publication
(10) Pub. No.: US 2015/0141180 A1
(43) Pub. Date: May 21, 2015

(54) HIGH STRAIGHTNESS ARROW AND METHOD OF MANUFACTURE FOR THE SAME

(71) Applicant: Aldila Golf Corp., Poway, CA (US)

(72) Inventor: MARTIN CONNOLLY, San Marcos, CA (US)

(73) Assignee: ALDILA GOLF CORP., Poway, CA (US)

(21) Appl. No.: 14/605,925

(22) Filed: Jan. 26, 2015

Related U.S. Application Data
(63) Continuation-in-part of application No. 13/298,287, filed on Nov. 16, 2011, now Pat. No. 8,939,753.
(60) Provisional application No. 61/413,983, filed on Nov. 16, 2010.

(51) Int. Cl. F42B 6/04; B32B 38/00; B32B 37/06

(52) U.S. Cl. CPC F42B 6/04; B32B 37/06; B32B 38/00; B32B 38/0004; B32B 2305/38; B32B 2038/0088; B32B 2597/00
USPC 473/578; 156/83

(57) ABSTRACT

The high straightness arrow made by the process in the present invention is designed to improve the straightness of the archery arrow. A chamber and a mandrel are made of dissimilar metals. The chamber includes walls creating an external housing and defining an internal airspace. Once the mandrel covered with carbon fiber is positioned through chamber, the mandrel ends are secured, forming an assembly, to straighten mandrel. When heated simultaneously, the different coefficients of thermal expansion of chamber and mandrel cause the chamber to expand more than the mandrel, creating a natural tension along mandrel resulting in a near perfectly straight shaft. As the assembly cools, the mandrel and chamber return to their original length, yet the shaft retains its straightened form. Thus this manufacturing process yields an arrow shaft that is straighter than shafts made of the same materials but with a traditional manufacturing technique.

### RELATED APPLICATIONS

This application is a Continuation-In-Part of, and claims the benefit of priority to, U.S. Utility patent application Ser. No. 13/298,287, filed Nov. 16, 2011, entitled “High Straightness Arrow and Method of Manufacture,” and currently co-pending, which in turn claims priority to and the benefit of U.S. Provisional Patent Application Ser. No. 61/413,983, filed on Nov. 16, 2010, entitled “High Straightness Arrow and Method of Manufacture.”

### BACKGROUND OF THE INVENTION

1. Field of the Invention

The present invention relates generally to a method for manufacture of archery arrows, and more specifically to techniques for improving the straightness of the arrow and method of manufacture for the high straightness arrow. The present invention is more particularly, though not exclusively, useful as a manufacturing technique which provides for more consistent, high-straightness to the arrows.

2. Description of the Related Art

In the archery industry, there is a consistent drive towards manufacturing arrows having improved straightness. Specifically, an arrow's flight path is determined in large part by the weight, flexibility or “spine,” and straightness of the arrow shaft.

Some deviation from a “perfectly straight” arrow shaft is generally expected from present manufacturing processes. Straightness is ordinarily referred to in terms of a Total Indicator Reading (“TIR”). In the case of an arrow shaft, TIR is the difference between the maximum and minimum measurements, that is, readings of an indicator, on the cylindrical or contoured surface of the shaft, showing its amount of deviation from flatness. While an arrow may appear perfectly straight to the naked eye, it is not uncommon to find an arrow shaft with a TIR of 0.010 inches, which is extreme in the archery world. Such a measurement gives a direct reference to how straight the arrow shaft is along its overall length. Common target and hunting arrows come with a 0.003 to 0.006 straightness rating referring to the TIR, indicating the 0.003 arrow is twice as straight at the 0.006 arrow.

There tends to be some inconsistency within the industry with reference to TIR and straightness. Often straightness is referred to as a “plus-minus” measurement wherein a “0.003 plus-minus” would actually be a 0.006 absolute measurement. For purposes of this application, the absolute measurement will be utilized.

Arrow “spine” refers to the arrow's degree of stiffness, that is, a measured resistance to bending. The spine of an arrow is an expression of the stiffness of an arrow shaft, considered in two ways: static and dynamic spine. Static spine may be measured by the amount of sag, or “spine deflection,” a given arrow shaft exhibits when an 880 gram (1.94 lbs.) weight is suspended from the center of an arrow. This common standard for measuring spine deflection requires a 29″ arrow shaft supported by two points, which are 28″ apart. The number of inches the arrow deflects or bends due to the weight is the spine size or measurement of an arrow. Common static spine may be as much as 0.25 inches or as minimal as 0.003 inches. It follows then, that a stiffer arrow will have less spine deflection and a more limber arrow will have more spine deflection.

However, arrows don't perform under static conditions. Arrows perform under dynamic conditions subject to many forces. A hanging weight does not directly represent forces applied to arrows when fired and when in flight, so static spine is ordinarily utilized only as a benchmark for predicting dynamic spine because it is relatively easy to measure.

Dynamic spine describes the way an arrow reacts to the stored energy of a bow that is transferred to an arrow or bolt (in the case of a crossbow) when it is fired. Several factors determine the way an arrow is going to react when fired from a bow, including method of release (fingers or mechanical release), amount of energy applied by the bowstring upon release, the bow's cam system, the weight of the arrow, the (static) spine of the arrow, length of the arrow, point weight, nock weight, and fletching weight. Even nock set material, along with bowstring material can influence dynamic spine. There are numerous variables affecting dynamic spine, thus static spine is most commonly used to classify arrows. As used in this application the term “spine” will refer to static spine, unless otherwise indicated.

During flight, an arrow experiences oscillations along the axis of the shaft following release from a bow. As the bow string is released, the potential energy stored in the bow and bowstring is transferred to the arrow, propelling it forward. This force bends the arrow shaft slightly, inducing an oscillation perpendicular to the shaft's axis following departure from the bow that continues throughout the arrow's flight until target impact.

The frequency and magnitude of these oscillations affect the overall trajectory, velocity, and accuracy of the arrow. The oscillations increase drag, waste energy that would otherwise be applied to forward velocity, and increases the required vertical trajectory of the fired arrow in order to compensate for the drag and reduced velocity.

Moreover, the combination of the oscillations of the arrow along its length with the rotation of the arrow caused by the air passing over the fletching induces an asymmetrical drag on the body of an arrow or bolt, causing a corkscrew-shaped flight path, which is not a perfectly straight line. The corkscrew may range from barely perceptible to several inches across. As the magnitude of these oscillations increases, the corkscrew shaped flight path gains a larger radius, ultimately manifesting itself in a larger elliptical error and lowering the arrow's overall accuracy. Thus, the more the manufacturing processes can minimize an arrow shaft's propensity to oscillate or vibrate in flight, the more accurate the arrow will be.

In light of this consistent pursuit of arrow straightness, a high straightness arrow and method of manufacture have been developed. The high straightness arrow is manufactured from carbon fiber materials generally known and used in the archery industry. Arrows manufactured using the technique of the present invention are consistently more straight than arrows made using the same materials but with a traditional manufacturing technique.

### SUMMARY OF THE INVENTION

The high straightness arrow in the present invention is designed to improve the straightness of the archery arrow by adopting a new manufacturing technique and method of using carbon fiber materials. Arrow shafts constructed utilizing this method have consistent TIR measurements of 0.001 inches, or plus-minus 0.0005 inches. This results in arrow shafts 60 percent straighter than those commonly found in the market.

In a preferred embodiment, a cylindrical chamber is designed to enclose a mandrel, the chamber has walls or covers on each end that creates an external housing and defines an internal airspace. The chamber and mandrel are made of dissimilar metals with different coefficients of thermal expansion; the chamber assembly having a higher coefficient of thermal expansion than the mandrel. The mandrel is wrapped with carbon fiber material and resin and inserted into the chamber to later be heat-cured. The mandrel may be threaded on its ends that extend outside chamber. Once the mandrel wrapped with the carbon fiber is positioned through or within the chamber, fasteners are tightened securely to the ends of the mandrel, forming an assembly to straighten the mandrel. The entire assembly is then heated evenly. Due to the greater coefficient of thermal expansion of the chamber assembly than that of the mandrel, when they are heated equally and simultaneously, the chamber length expands to a greater degree than the length of the mandrel, placing the mandrel under tension. The heat further causes the carbon fiber mixture to cure, producing a hollow carbon fiber shaft wrapped around the mandrel.

Once brought up to temperature, a difference in length of chamber and mandrel creates a natural tension along the mandrel which results in a near perfectly straight carbon fiber shaft. As the assembly cools, the mandrel and chamber return to their original length and size, yet the shaft retains its straightened form. As a result, this manufacturing process yields an arrow shaft that is significantly straighter than shafts made of the same materials but with a traditional arrow manufacturing technique. Shafts produced using this method routinely produces a straightness factor of 0.001, some 60% straighter than the straightest arrows advertised in the market.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a side view of a standard target arrow, depicting the interaction of the arrow shaft, arrowhead, nock, and fletching.

FIG. 2 is a plan view of an arrow just after being fired from a bow (not shown), depicting a possible deflection pattern along the longitudinal axis of the arrow shaft as it leaves the string of the bow and flies toward a target;

FIG. 3 is a diagrammatic view of the corkscrew flight path of a common arrow oscillating in flight;

FIG. 4 is a diagrammatic view of an arrow with an illustration of lateral flexure or spine deflection of an arrow due to manufacturing abnormalities or lateral deflection that occurs when the arrow is fired;

FIG. 5 is a cross-sectional view taken along lines 4-4 of FIG. 4, showing the typical cross section of an arrow;

FIG. 6 is a perspective view of the exterior of a preferred embodiment of a chamber used to manufacture a high straightness arrow shaft and method of manufacture of the present invention, showing the mandrel wrapped in carbon fiber material (shown in dashed lines) on the interior of the chamber and the fasteners securing the mandrel and end covers in place and the holes formed in the end walls allowing complete and even heating of the interior and exterior of the assembly;

FIG. 7 is an exploded view of the preferred embodiment of FIG. 6, showing the insertion of the mandrel wrapped with carbon fiber into the chamber, and the fasteners used to hold the mandrel in place and under tension before and during the heating process;

FIG. 8 is a diagrammatic view of a mandrel and arrow shaft in the middle of the manufacturing process, equipped within the chamber of FIG. 6 used to manufacture the high straightness arrow and method of manufacture in the present invention with mandrel, shaft, and nuts illustrating the expansion of the chamber when heated;

FIG. 9 is a graphical representation of the correspondingly expanded lengths of the chamber and mandrel in the present invention on a graph of length versus heated temperature of the associated metals;

FIG. 10 is a perspective view of multiple chamber assemblies stacked as they might be in an oven during heat treatment;

FIG. 11 is a preferred embodiment of a quick release mechanism for the chamber assembly of the method of manufacture for a high straightness arrow shown as a lever style tensioning system enabling rapid construction of the assembly or rapid removal of the mandrel and completed high straightness arrow shaft;

FIG. 12 is an alternative embodiment of a quick release mechanism for the chamber assembly of the method of manufacture for a high straightness arrow showing an adjustable clip used to secure one end of the mandrel enabling rapid construction of the assembly or rapid removal of the mandrel and completed high straightness arrow shaft;

FIG. 13 is an alternative embodiment of a quick release mechanism for the chamber assembly of the method of manufacture for a high straightness arrow showing a clevis pin used to secure one end of the mandrel enabling rapid construction of the assembly or rapid removal of the mandrel and completed high straightness arrow shaft;

FIG. 14 is a side view of a manner of applying carbon fiber material to a mandrel by wrapping the carbon fiber around the mandrel longitudinally, showing the edges of the sheet of carbon fiber material where they meet at a seam;

FIG. 15 is a side view of a preferred weave pattern for applying carbon fibers to a mandrel prior to curing, by weaving carbon fibers along the axis of the mandrel, eliminating the requirement of a seam; and

FIG. 16 is a flow chart, outlining the process of the method of manufacture for a high straightness arrow, depicting in blocks the process from selecting the appropriate carbon fiber weave and desired strength of the ultimate arrow, selecting the length of the desired arrow shaft, application of the carbon fiber material to the exterior of the mandrel, inserting the mandrel in the chamber, securing the mandrel to the opposite walls of the chamber, evenly and simultaneously heating the assembly.

### DETAILED DESCRIPTION OF THE INVENTION

Referring initially to FIG. 1, a standard arrow is shown and generally designated 100. Arrow 100 includes a shaft 102 with a tip end 104 equipped with an arrowhead 106 and tail 110 equipped with fletching 108 and a nock 112. Arrow 100 is a standard target arrow, commonly used in a bow (not shown).

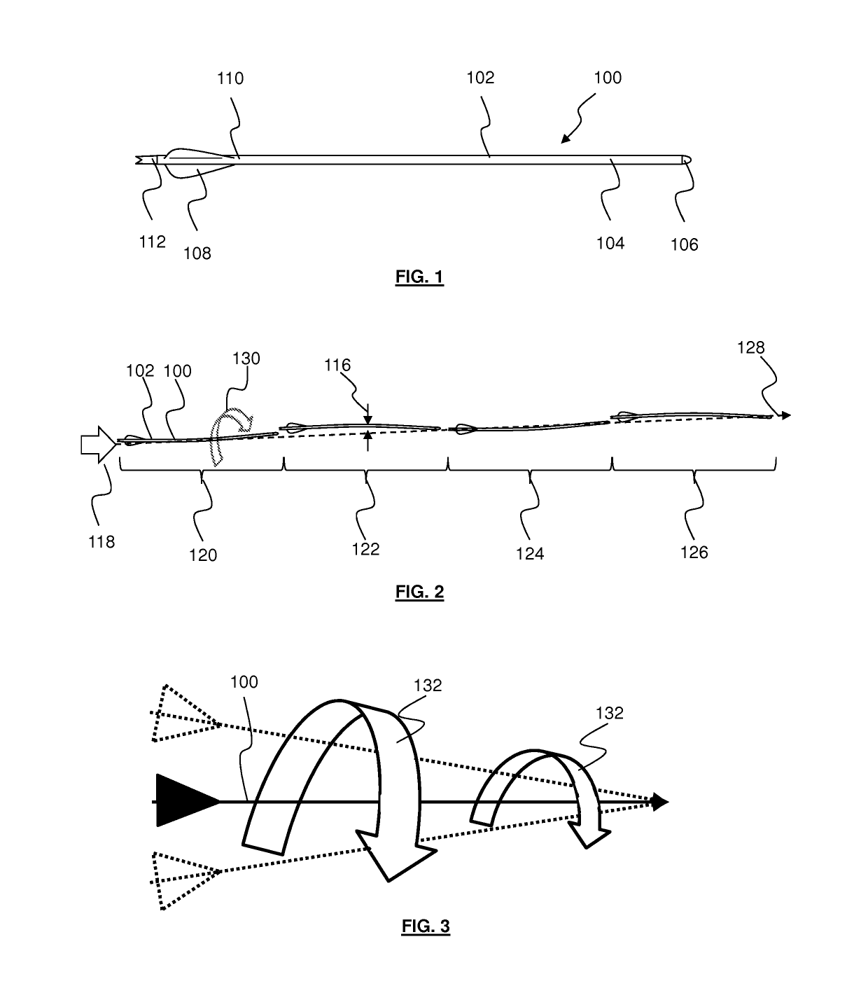

Referring now to FIG. 2, an arrow 100 fired from a bow (not shown) is depicted. The arrow 100 is shown with lateral deflection 116. As the arrow 100 is fired, the potential energy stored in the bow (not shown) is transferred as force 118 to tail 110 of arrow 100 and turned into kinetic energy as arrow 100 is propelled on its flight path 128 toward a target (not shown).

Arrowhead 106 may be a small target tip, or a larger hunting broad head (not shown), which tend to be considerably heavier than a simple target tip. In a static, non-flight environment, a heavy arrowhead 106 makes the arrow 100 front-heavy. In flight, however, the fletching 108 on the tail 110 of the arrow 100 provides additional surface area on which air can act, causing drag on the tail 110. An increase in the weight of the arrowhead 106 causes arrow's 100 center of mass to move forward along the shaft 102 (toward the tip 104) toward the center of pressure, where aerodynamic forces are centered. Stable flight is then dependent on aerodynamic forces, namely drag on the fletching 108, to stabilize the flight of the arrow 100.

When the arrow 100 is fired from a bow, the sudden application of force 118 to arrow 100 causes the arrow 100 to bend slightly under the compressive force 118 acting on the tail 110 of the arrow 100. At the instant an archer releases the bowstring, arrow 100 is momentarily trapped between the forward motion of the bowstring and the combined static load of arrowhead 106 and shaft 102. The amount of deflection 116 arrow 100 experiences is affected by several factors including the length of the arrow shaft 102, the arrow's static spine, and the respective weights of arrowhead 106, fletching 108, and nock 112, among other things. Ordinarily, the longer shaft 102 is, the more easily this compressive force can bend shaft 102 and the more deflection 116 is realized. The compressive force 118 is transient against the tail 110 of arrow 100 because arrow 100 immediately begins accelerating out of bow 114 toward its target.

The initial compression of the arrow 100 causes deflection 116 and induces an oscillation that continues for the duration of its flight. The arrow 100 will then flex and vibrate with a given frequency based on the length and composition of the arrow 100 as it flies. The aerodynamic force generated by fletching 108 straightens the flight path 128 of arrow 100, helping it reach the intended target accurately. Some fletching 108 is designed to make arrow 100 spin along its axis; this can further improve accuracy but comes at the cost of speed since some of arrow's 100 initial kinetic energy must be converted to rotation.

FIG. 2 further shows arrow 100 at stage 120 immediately after it is fired from a bow (not shown). At stage 122, shaft 102 deflects in the opposite direction from stage 120, which is indicative of the aforementioned oscillations, as shown in stages 124 and 126. FIG. 2 further shows that while shaft 102 deflects left and right with the oscillations of the arrow 100, a properly fired arrow 100 will remain on its flight path 128, oscillating about the axis of shaft 102.

Once the arrow 100 is fired, the fletching 108 is pushed by the airflow passing over the fletching 108. The air acts on the fletching 108, imparting a rotation 130 on the tail of the arrow 100 (depending on the orientation of the fletching 108). This rotation is a spiral similar to a bullet fired through a rifled gun barrel or a properly thrown football. Depending on the placement and shape, the fletching 108 can induce different spiral speeds in either direction, affecting arrow's 100 velocity, trajectory, and kinetic energy.

As shown in FIG. 3, as the arrow 100 oscillates and spirals through the air, flight path 128 of the arrow can become corkscrew-shaped depending on the magnitude of the oscillations, straightness of shaft 102, and velocity of arrow 100. A corkscrew-shaped flight path 132 of arrow 100 is very undesirable as it induces tremendous inaccuracies. Such a corkscrew-shaped flight path 132 may be subtle and barely visible or not visible at all by an archer, but may also be extreme and lead to noticeable inaccuracies. The corkscrew-shaped flight path 132 is often caused by the oscillations of the arrow 100 in flight combined with its spiral. Often, the rotation and oscillation create an asymmetrical aerodynamic drag creating a corkscrew motion. An arrow 100 that has inherent manufacturing defects, is not perfectly straight, is poorly matched to a bow, has an excessively limber spine of shaft 102, shaft 102 weight is too light, or the arrowhead 106 is improperly chosen, among other things, will exacerbate the corkscrew-shaped flight path 132. Many other factors external to the design and build of the arrow 100 may also cause such a corkscrew, such as impact of the fletching 108 on the bow as the arrow 100 is released. FIG. 3 depicts, in dashed lines, the travel of the tail 110 of arrow 100 in a corkscrew flight path 132. While a high straightness arrow 100 will not completely remove the possibility of the corkscrew-shaped flight path 132, it minimizes or eliminates asymmetrical drag due to any curvature in an arrow shaft 102.

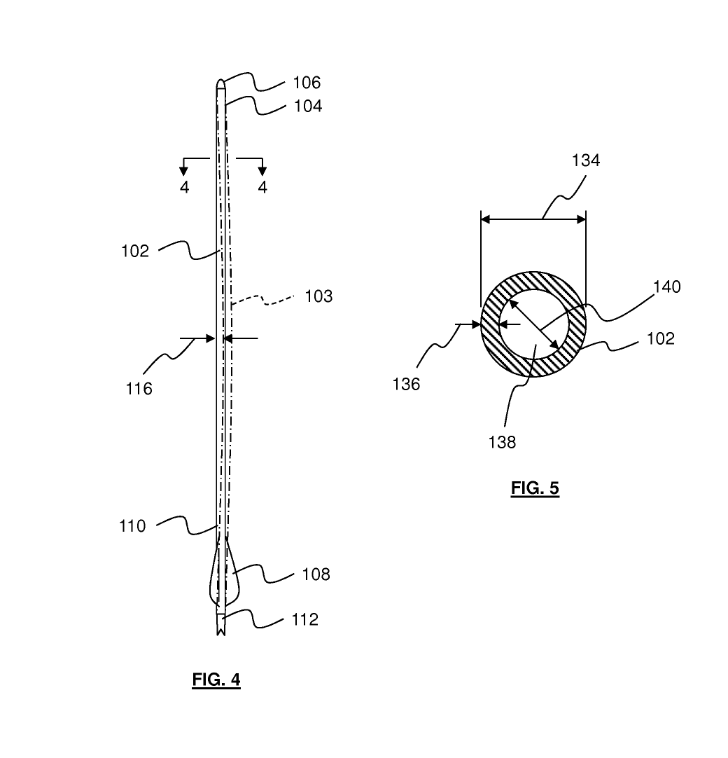

Referring now to FIG. 4, arrow 100 is again shown, manufactured with an inherent, yet unwanted, curvature shown by dashed lines 103. This curvature results in nonlinear flight, adding to arrow's 100 inaccuracies. Such a bend, or other manufacturing abnormality, can cause an uneven weight distribution about the axis of shaft 102 and affects arrow's 100 center of mass, precision, and accuracy. As arrow 100 spirals along flight path 128, the spiral becomes eccentric due to the uneven weight distribution caused by the curvature of the arrow 100. The eccentric spiral causes uneven aerodynamic drag over the surface of arrow 100 causing the arrow to stray from its flight path 128 toward the target. The uneven aerodynamic drag may also induce a larger corkscrew 132 decreasing the precision and accuracy of the shot. Thus, a high straightness arrow 100 that has a more even weight distribution will maintain an axis of rotation more closely aligned with the shaft 102 axis, preventing the rotating arrow 100 from acquiring an eccentric spiral, resulting in a corkscrew-shaped flight path 132.

FIG. 5 is a cross-sectional view of the arrow 100 as taken along lines 4-4 of FIG. 1, which illustrates a shaft 102 having a diameter 134, a wall thickness 136, and defines an internal bore 138 and an internal diameter 140. These dimensions can vary depending on the type of arrow being manufactured and can be increased or decreased depending on the materials used in shaft 102, as well as the style of arrow being manufactured.

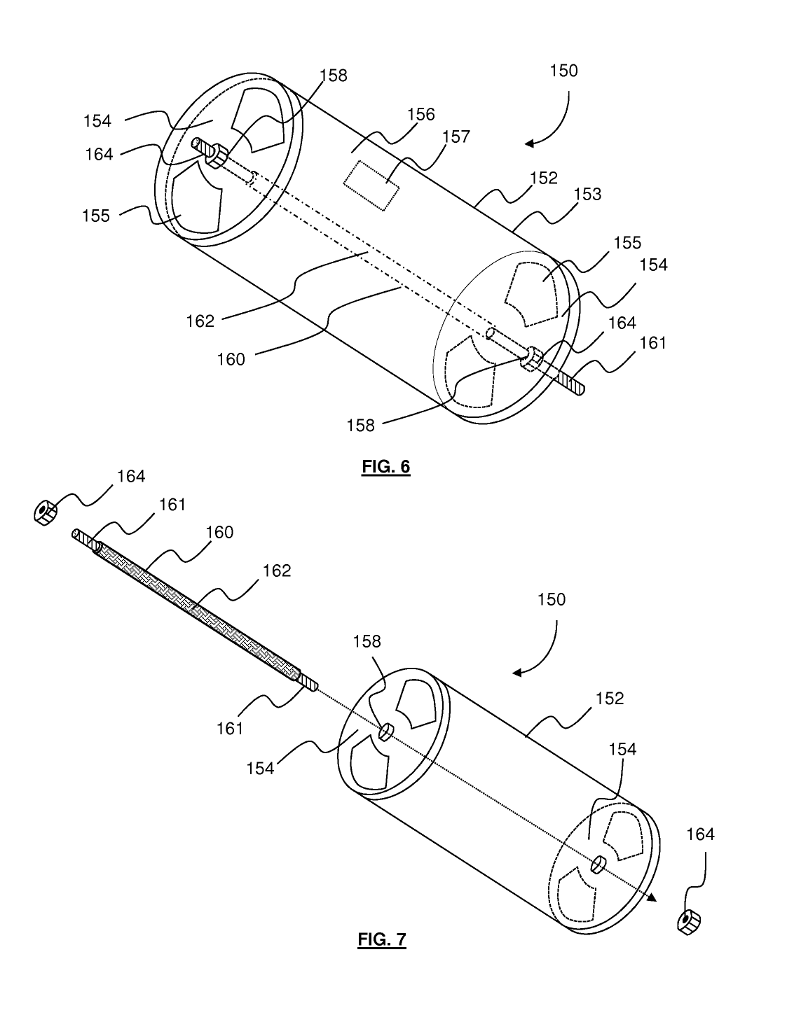

Referring now to FIG. 6, the chamber assembly of the method of manufacture for a high straightness arrow is depicted and generally designated 150. Chamber assembly 150 has a chamber 152 and walls 154 creating an external housing that defines an internal airspace 156. Walls 152 are each formed with holes 158 through which mandrel 160 can be inserted such that mandrel 160 passes longitudinally through chamber 152 and internal airspace 156. Mandrel 160 may be a solid rod or alternatively a hollow, tubular rod, based on the application and desired coefficient of thermal expansion (discussed below). It is to be appreciated that chamber 152 may be made such that the mandrel 160 wrapped with a carbon fiber material 162 may be inserted. Carbon fiber material 162 will become high straightness arrow shaft 102 once cured. It should also be appreciated by those skilled in the art that while carbon fiber is used in the preferred embodiment, other heat curable composite fiber materials may be utilized without departing from the spirit of the present invention.

In a preferred embodiment, chamber assembly 150 can be formed of multiple pieces, wherein at least one wall 154 is removable, or wherein holes 158 are sized to pass mandrel 160 wrapped with carbon fiber material 162 through the internal airspace 156 of the chamber 152. Mandrel 160 may have threads 161 on its ends that extend outside chamber 152. Once mandrel 160 with carbon fiber material 162 is positioned through chamber 152, fasteners 164 and 166 are applied to threads 161 and tightened, applying tension to straighten mandrel 160.

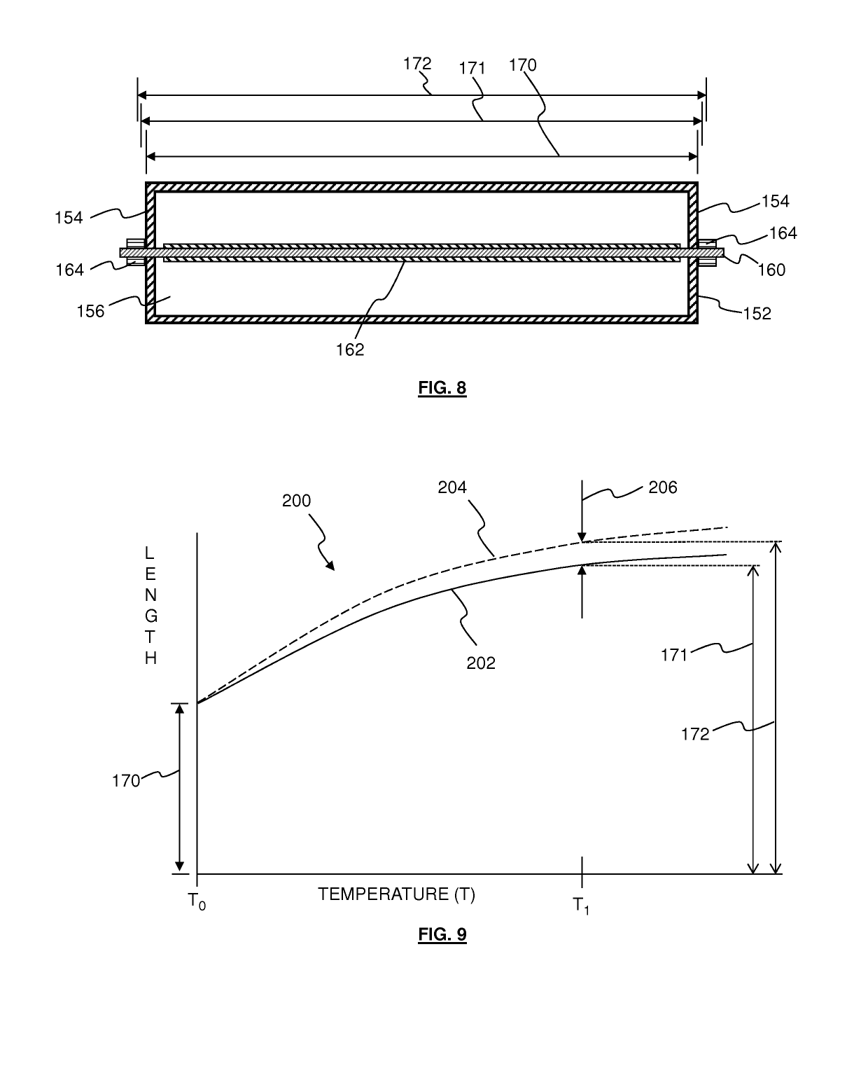

FIG. 6 further depicts the mandrel 160, shown protruding through walls 154 on either end of chamber 152 as it extends through the chamber 152. Mandrel 160 is wrapped with carbon fiber material 162 (shown in dot-dash lines) as shown in internal airspace 156 of chamber assembly 150. Fasteners 164 are shown here as nuts, screwed onto threads 161 of mandrel 160 then tightened to apply tension, allowing the manufacturer to secure mandrel 160 to chamber 152 with the carbon fiber material 162 in the internal airspace 156. Securing fasteners 164 to the ends of mandrel 160 applies a tension to the mandrel 160, which is a critical aspect of the present invention. It is to be appreciated by those skilled in the art that other types of fasteners may be utilized, as will be shown in FIGS. 8 through 10.

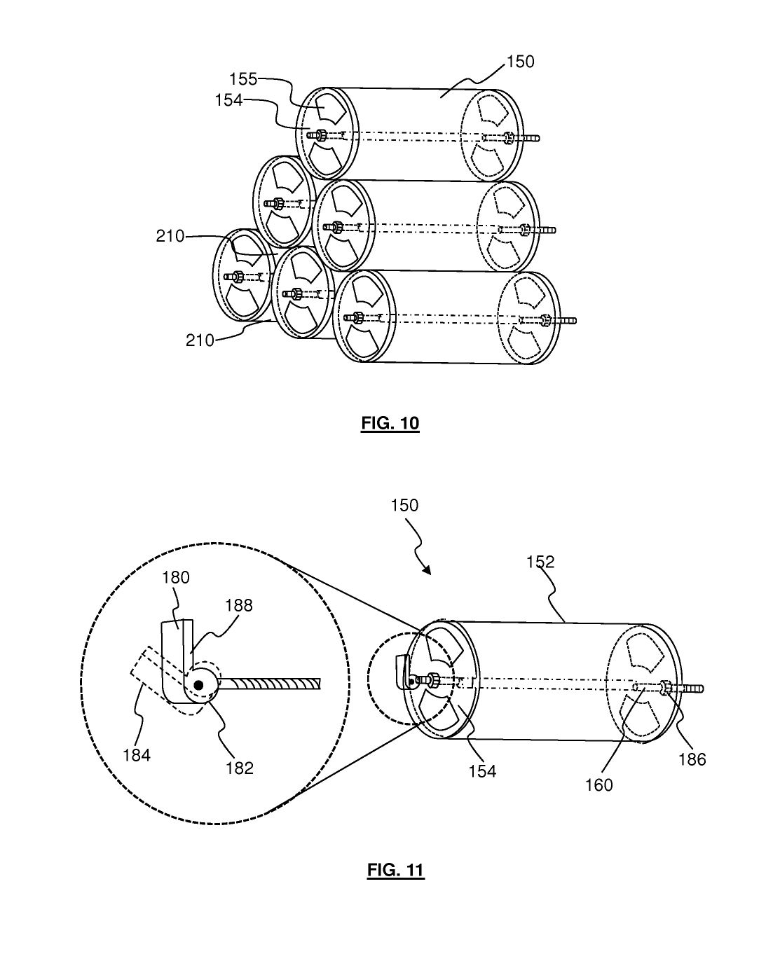

In a preferred embodiment, chamber 152 is cylindrical, allowing even and uniform heating of chamber assembly 150, and a central positioning of mandrel 160 within interior airspace 156 along the axis of chamber 152. A cylindrical chamber 152 is further advantageous for heat transfer into and around chamber assembly 150 due in part to the spaces resulting from stacking a plurality of chamber assemblies 150 during the heating process, as shown in FIG. 10, below. It is to be appreciated by those skilled in the art that the shape of chamber 152 may be any reasonable shape, or suitably modified for different heating regimes without departing from the spirit of the invention.

In a preferred embodiment, chamber 152 and mandrel 160 are made of dissimilar metals. Specifically, the coefficient of thermal expansion of chamber 152 is greater than that of mandrel 160 such that when they are heated simultaneously, the chamber 152 length expands more than the mandrel 160 length. The greater expansion of the chamber 152 places the mandrel 160 under tension, straightening it for the duration of the heating cycle. In a preferred embodiment, walls 154 are formed with cavities 155 in order to provide more complete circulation of heat through the interior airspace 156 of chamber 152 such that the entire assembly 150 is heated evenly. In an embodiment, at least one cavity 157 is formed in each wall 154, however it is to be appreciated by those skilled in the art that a plurality of cavities 157 may be practical for a given design, without weakening the structure of the walls 154.

FIG. 7 is an exploded view of the embodiment of FIG. 6, showing a possible manner in which mandrel 160 wrapped with carbon fiber material 162 is inserted into chamber 152. Fasteners 164 are applied to the ends of mandrel 160 and tightened. Shown here for fasteners 164 are threaded nuts. Alternative embodiments may include washers or use threaded nuts with wide bases in order to maintain tension on the mandrel 160.

In an alternative embodiment, one or both walls 154 are removable. Such an embodiment enables the use of different metals providing different coefficients of thermal expansion. For instance, the mandrel 160, chamber 152, and the walls 154 may each be formed from different metals in order to maximize expansion of the chamber and the resulting tension. Such an embodiment also enables simplified construction of chamber 152, easy replacement of walls 154, or simpler insertion of the mandrel 160.

Referring now to FIG. 8, a cross section of chamber assembly 150 is shown with mandrel 160 and carbon fiber material 162 inserted and secured with fasteners 164. Walls 154 are shown on the left and right of chamber 152. The carbon fiber material 162 is shown in cross section, applied to mandrel 160. As shown in this Figure, chamber assembly 150 is loaded with mandrel 160 and carbon fiber material 162, while fasteners 164 are securely tightened. In this configuration, chamber assembly 150 has a length 170 at the starting temperature. Once fasteners 164 are tightened, chamber assembly 150 is placed into an oven, kiln, or other heat source. The heat source heats chamber assembly 150 such that chamber assembly 150, mandrel 160, and carbon fiber material 162 are exposed to a uniform heat. In a preferred embodiment, chamber 152 may be tubular so that the distance between the longitudinal walls 153 of the chamber 152 and mandrel 160 are the same along the length of the mandrel 160. Once heated, chamber assembly 150 expands to a length 172 that is greater than the expansion length 171 of mandrel 160.

Referring to FIG. 9, a graphical representation 200 of the correspondingly expanded lengths 171 and 172 of the chamber assembly 150 and mandrel 160 are shown. Specifically, graph 200 includes a representative graph of the expanded length of the chamber assembly 150 as a function of temperature. Chamber assembly 150 begins with original length 170 at T1. As the temperature increases to T2, the length of chamber assembly 150 increases along dashed line 204 to length 172. The length of the mandrel 160, however, begins at length 170, yet increases along solid line 202 at a lesser rate. When the temperature reaches T2, there is a difference in length 206 between chamber 152 and mandrel 160 that creates a natural tension along mandrel 160, which results in mandrel 160 becoming near perfectly straight. As a result, carbon fiber material 152 cures, resulting in a near perfectly straight arrow shaft 102. While the difference in length 204 is not significant in magnitude, usually only fractions of an inch, this difference is sufficient to place mandrel 160 under enough tension to force it to be near perfectly straight.

As the chamber 152 and mandrel 160 cool, mandrel 160 and chamber 152 return to their original length, and shaft 102 retains its straightened form. As a result, this manufacturing process yields an arrow shaft that is straighter than shafts made with different techniques. Moreover, depending on the coefficient of thermal expansion, the circumference of the mandrel 160 expands slightly during heating and the carbon fiber material cures while the mandrel is in the expanded state. Once cooled, the circumference of mandrel 160 returns to its original size, allowing easier removal of the now complete shaft 102 because shaft 102 now has a greater inside diameter than the outside diameter of mandrel 160.

Referring to FIG. 10, multiple chamber assemblies 150 are stacked together, maximizing space and use of the oven, kiln, or other heat source used to cure the carbon fiber material 162. The cavities 155 in walls 154 become more important in this situation as they allow more effective circulation of heat throughout the interior airspace 156 of the chamber assemblies 150. This Figure depicts six exemplary chamber assemblies 150 stacked in a pyramid. However it is to be appreciated by those skilled in the art that the only limitation on the number of assemblies that can be heated simultaneously is the size and capacity of the heat source. Additionally, the cylindrical shape of chamber assembly 150 further provides more effective heat transfer when multiple chamber assemblies 150 are stacked since the outside of each of the chamber assemblies 150 only come in contact with adjacent chamber assemblies 150 in limited areas around the circumference of each chamber 152. This leaves significantly more surface area on the exterior of each chamber assembly 150 on which the heat can act as well as voids 210 between the chamber assemblies 150 through which heat can flow.

Referring now to FIG. 11, a preferred embodiment of a quick release system is depicted. Previous Figures and embodiments make use of a threaded nut for a fastener 164, which is screwed onto the threaded ends of mandrel 160 to secure mandrel 160 in place in chamber 152 and to apply tension. This system is useful because it allows the manufacturer to set an appropriate tension to the assembly 150 prior to heating. However, this tends to be a slower process because it requires the installation and removal of at least one nut for proper insertion and removal of mandrel 160. In an embodiment, the pitch of the threads on mandrel 160 and the nuts may be increased thereby decreasing the number of turns required for tightening. However, other options are also possible.

The quick release system described in FIG. 11 consists of a lever-actuated system that allows securing of the mandrel 160 in chamber 152 and application of a tension along its axis. This system operates similar to that of a bicycle wheel skewer: the mandrel 160 is formed with a lever 180 on one end that rotates perpendicular to the longitudinal axis of mandrel 160. The bottom of lever 180 has eccentric face 182 that meets the outer face of wall 154 on the outside of hole 158. Lever 180 is placed in the release position 184, while a nut 186 is screwed onto the opposite end of mandrel 160. Once nut 186 is in the desired location, lever 180 may be rotated toward tension position 188 such that the eccentric face of lever 180 increases the pressure applied along the axis of mandrel 160. Nut 186 may be adjusted to increase or decrease the amount of tension applied to shaft 160 when lever 180 is moved to tension position 188.

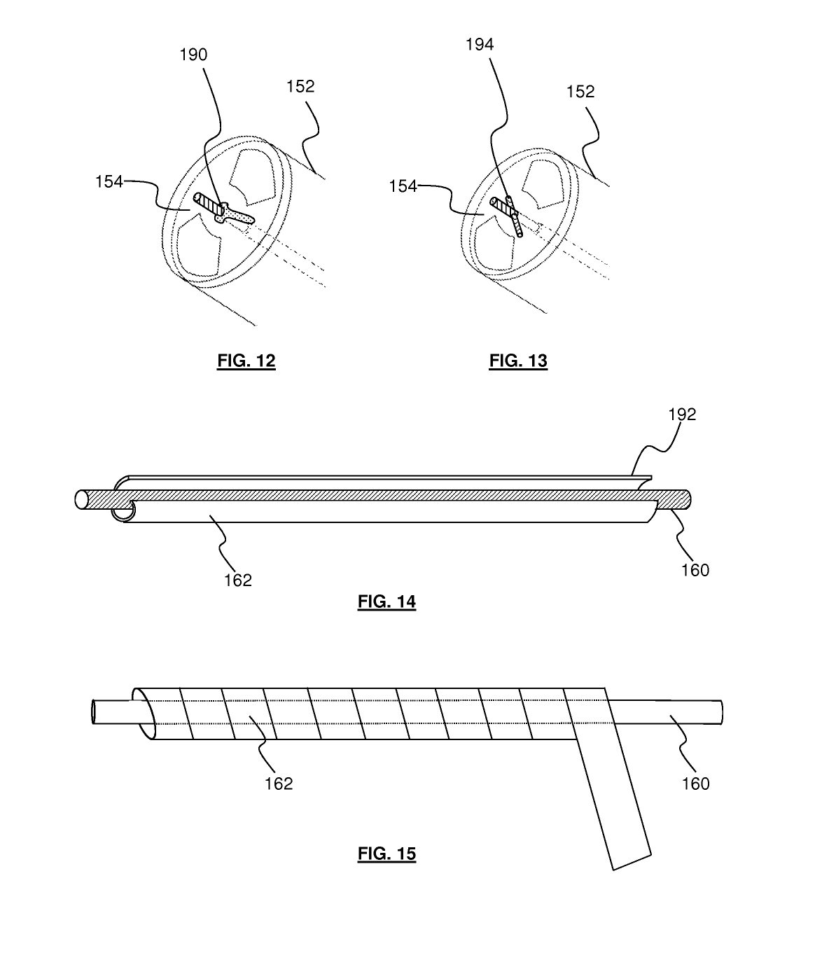

FIG. 12 depicts a clip system, wherein the mandrel 160 has a fastener (not shown) on one end similar to FIG. 11, however there is a clip 190 attached to a preset point on the end of mandrel 160. Tension may be applied either by precise positioning of clip 190 or by the fastener attached to the opposite end of the mandrel 160.

FIG. 13 depicts a pin-and-hole method, allowing the insertion of a clevis pin 194 through a correspondingly sized and horizontally disposed hole through the end of mandrel 160. While the quick release systems of FIGS. 12 and 13 provide a more expeditious manner of insertion and removal of the mandrel 160, neither apply tension in as easy and efficient a manner as FIG. 11.

Referring now to FIGS. 14 and 15, two different manners of applying carbon fiber material 162 to mandrel 160 are shown.

In FIG. 14, the carbon fiber material 162 is applied as a sheet 192. The sheet 192 of carbon material fiber material 162 may be constructed of any of a myriad of weave patterns and wrapped or rolled around the mandrel 160 and then inserted into the chamber 152 and heat cured. The thickness (not shown) of the sheet 192 in this Figure may be varied or tapered as desired providing different wall thickness 136 of shaft 102.

In the past, arrow shafts have been constructed of extruded carbon fibers laid along the axis of an arrow shaft 102. While this improves stiffness and resistant to forces applied perpendicular to the shaft's 102 axis, the hoop strength of the shaft 102 is decreased because the fibers are orientated in a parallel manner. Decreased hoop strength increases the chances of arrow shaft 102 splintering upon impact with a target. The “rolling” method depicted in FIG. 14 is one method to improve hoop strength and prevent splintering.

However, while the hoop strength and axial strength of this method is improved by rolling the sheet 192 onto mandrel 160, one particular drawback of this method of carbon fiber forming is the seam that results from the wrapping action. This seam creates an imbalance in the spine consistency of the shaft 102, such that shaft 102 is slightly stiffer at one point around the circumference of shaft 102. With the seam in the final construction of shaft 102, an unequal distribution of spine deflection will result, creating stiffness that is not uniform as arrow shaft 102 is rotated about its longitudinal axis. That is, one may experience varying spine deflection measurements and as the shaft 102 is rolled about it axis and tested due to the seam in sheet 192. Ultimately this can result in the aforementioned eccentric rotation and lead to reduced accuracy and precision.

FIG. 15 depicts a preferred embodiment wherein the carbon fiber material 162 is woven about the circumference and length of mandrel 160, such that there is no longitudinal seam. Weaving the fibers in this manner provides increased axial strength, stiffness, and evenly distributes forces such that the hoop strength of the resulting shaft 102 is significantly improved.

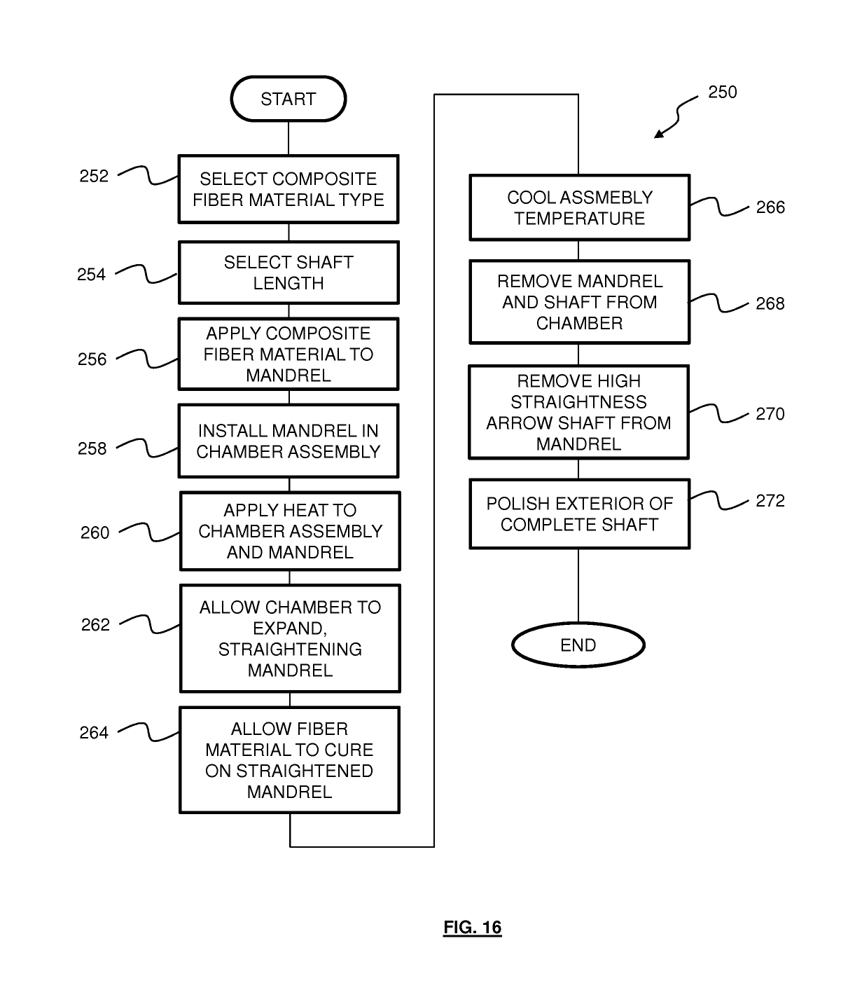

Now referring to FIG. 16, a block diagram outlining the method of manufacture for a high straightness arrow is depicted and generally labeled 250. The method 250 begins with step 252 wherein the manufacturer selects the material with which the arrow shaft 102 will be constructed. Carbon fiber is the preferred material and is commonly used in the industry. Carbon fiber is typically heat cured, often requiring extreme temperatures to complete the curing process. It is to be appreciated by those skilled in the art that other composites, composite fiber material, or materials apart from carbon fiber may be employed without departing from the intent or spirit of the present invention.

Carbon fiber can vary significantly from manufacturer to manufacturer in fiber length, fiber thickness, weave pattern, weave thickness, and various other characteristics. Step 252 is significant in that it allows the manufacturer or shaft designer to tune the resulting shaft 102 to the proper tolerance, strength, and spine.

In step 254, the manufacturer selects the length of the shaft 102 to be completed. This will determine the minimum length of chamber 152. The length of shaft 102, along with the composition of the material 162 (carbon fiber) used will affect the ultimate stiffness and weight of the arrow. A shorter arrow shaft 102 will exhibit less spine deflection than a longer shaft 102 composed of identical materials, thereby acting stiffer than its longer counterpart.

In step 256, mandrel 160 is covered with the selected amount and composition of carbon fiber material 162. There are several methods that may be used to apply the material to the mandrel 160; two of the possible methods are shown in FIGS. 14 and 15. Carbon fiber may be applied in a sheet 192, wrapped around the mandrel 160, extruded down the length of mandrel 160, or the fibers may be woven in a circular pattern around the circumference down the length of mandrel 160 creating what will become shaft 102 of a high straightness arrow of the present invention. Further, in an alternative preferred embodiment, the material can bound to the exterior of mandrel 160 with an adhesive, maintaining the material's position prior to the start of the heat-curing process in step 260.

Step 258 describes the placement of the mandrel 160 within the chamber assembly. In this step, the mandrel 160 is either inserted into the chamber 152 through holes 158 in walls 154 or attached in the case one or both of the walls 154 is removable from chamber assembly 150. Once inserted, fasteners 164 are utilized to secure mandrel 160 in chamber 152 and apply an initial amount of tension to mandrel 160. While the amount of expansion of chamber 152 is not extreme, only measuring fractions of an inch, this initial tension aids the process by ensuring sufficient tension is realized during heating.

In step 260, the manufacturer applies heat to chamber assembly 150. In the preferred embodiment of the present invention, multiple chamber assemblies 150 are stacked in a kiln or oven to cure the carbon fiber material applied to mandrel 160 within chamber assembly 150. Heat is then applied to the chamber assemblies 150 simultaneously and evenly and may make use of at least one cavity 155 in each wall 154.

Step 262 illustrates the heart of the present invention as chamber assembly 150 expands. The difference in the coefficient of thermal expansion characteristic of the metals used in construction of chamber 152 and mandrel 160 results in mandrel 160 being placed under tension because the metal in the walls of the chamber 152 have a higher coefficient of thermal expansion and thus experience a larger change in size as temperature increases. This change, while slight, provides sufficient tension to straighten mandrel 160 and for practical purposes, provide a perfectly straight platform for curing the carbon fiber shaft 102, completed in step 264.

In step 266, the chamber assembly 150, which includes mandrel 160, shaft 102, and chamber 152 are cooled, allowing all components to return to their starting size. As mandrel 160 cools, its circumference and length return to their starting size, but the now-cured carbon fiber shaft 102 retains its length and internal diameter 140. Accordingly, the internal diameter 140 of internal bore 138 of shaft 102 is the same size as mandrel 160 when heated to T2. In a preferred embodiment, the cooling of the chamber assembly 150 is done naturally, allowing the carbon fiber around mandrel 160 to slowly cure.

In an alternative embodiment of the present invention, step 266 employs a quenching process by which the cooling of chamber assembly 150 and shaft 102 is done by force, providing different structural characteristics of shaft 102. While quenching the chamber assembly may lead to brittle shafts 102 in some cases, some of the characteristics of quenching a heat-treating process, such as hardness of the resulting components, are desirable.

In step 268, chamber assembly 150 has cooled and mandrel 160 and shaft 102 can be easily removed from chamber 152. After the cooling is complete in step 266, mandrel 160 has a slightly smaller diameter than internal diameter 140 of cured shaft 102, thus in step 270 the high straightness arrow shaft 102 may be easily slid off mandrel 160 once removed from chamber 152. In an alternative embodiment, depending on the design of shaft 102 and the diameter and coefficient of thermal expansion of mandrel 160, removing shaft 102 may require a separate machine, a solvent, or other releasing agent to dissolve any adhesive coating used in step 256. Alternatively, further cooling of mandrel 160 may be useful to remove shaft 102.

Finally in step 272, the exterior of the new high straightness arrow shaft 102 is lightly polished to remove any imperfections and prepare it for any final coatings that might be required.

The resulting arrow shaft 102 has an absolute straightness factor of 0.001, or plus-minus 0.0005 inches. This method consistently produces arrows that are 60 percent straighter than the straightest arrows in the market.

While it has been shown what are presently considered to be preferred embodiments of the present invention, it will be apparent to those skilled in the art that various changes and modifications can be made herein without departing from the scope and spirit of the invention.

What is claimed is:

1. A high straightness arrow shaft having an improved straightness factor of 0.001 inches, manufactured by a process comprising the steps of:
selecting an arrow material type and shaft length;
applying a composite fiber material to a mandrel, said mandrel having a first end, a second end, and a first coefficient of thermal expansion;
installing said mandrel with said composite fiber material within a chamber assembly, said chamber assembly having a second coefficient of thermal expansion and a first wall disposed opposite a second wall, wherein said first end of said mandrel is secured to said first wall and said second end of said mandrel is secured to said second wall, and wherein said second coefficient of thermal expansion is greater than said first coefficient of thermal expansion;
applying heat to said chamber assembly and said mandrel;
allowing said mandrel to expand according to said first coefficient of thermal expansion and said chamber assembly to expand according to said second coefficient of thermal expansion, such that expansion of said chamber assembly results in a tension applied to said mandrel thereby resulting in said mandrel having improved straightness;
curing said composite fiber material on said mandrel, said composite fiber material now becoming a high straightness arrow shaft;
cooling said chamber assembly, said mandrel, and said high straightness arrow shaft, such that said chamber and said mandrel return to an original size; and
removing said high straightness arrow shaft from mandrel.

2. The process of claim 1, wherein said chamber assembly is cylindrical.

3. The process of claim 1, wherein said composite fiber material is carbon fiber.

4. The process of claim 1, wherein said composite fiber material is woven in a mesh around the circumference and down the length of said mandrel, such that there is no longitudinal seam in said composite fiber material.

5. The process of claim 1, wherein said composite fiber material is a sheet placed around the circumference and down the length of said mandrel, such that there is a longitudinal seam in said composite fiber material.

6. The process of claim 1, wherein an adhesive binds said composite fiber material to the exterior of said mandrel.

7. The process of claim 1, further comprising the step of applying a releasing agent to break down said adhesive, thereby allowing easy removal of said high straightness arrow shaft from said mandrel.

8. The process of claim 1, wherein the expansion of said mandrel according to said first coefficient of thermal expansion results in an internal diameter of said high straightness arrow shaft greater than an external diameter of said mandrel after cooling.

9. The process of claim 1, wherein at least one end of said mandrel is secured to said first wall, and the opposite end of said mandrel is secured to said second wall of said chamber by a quick release mechanism.

10. The process of claim 1, the process further consisting of the step:
polishing the exterior of the shaft to remove imperfections.

11. The process of claim 1, wherein the expansion of said mandrel according to said first coefficient of thermal expansion results in an internal diameter of said high straightness arrow shaft greater than an external diameter of said mandrel after cooling.

12. The process of claim 1, the process further consisting of the step:
stacking a plurality of assembled chamber and mandrel assemblies in a heat chamber to allow the plurality of assembled chamber and mandrel assemblies to be heated, cured, and cooled simultaneously;

13. The process of claim 1, the process further consisting of either “quench” cooling or slow cooling the chamber and mandrel assembly depending on the final desired characteristics of the high straightness arrow shaft.
